(19) United States
(12) Patent Application Publication
(10) Pub. No.: US 2016/0378005 A1
(43) Pub. Date: Dec. 29, 2016

(54) DEVELOPER, DEVELOPER CONTAINER, DEVELOPMENT APPARATUS AND IMAGE FORMING APPARATUS

(71) Applicant: Oki Data Corporation, Tokyo (JP)

(72) Inventor: Shin YAMADA, Tokyo (JP)

(21) Appl. No.: 15/162,141

(22) Filed: May 23, 2016

(30) Foreign Application Priority Data
Jun. 24, 2015 (JP) 2015-126095

(51) Int. Cl. G03G 9/087; G03G 9/08

(52) U.S. Cl. CPC G03G 9/08755; G03G 9/0804

(57) ABSTRACT

A developer contains at least a binder resin and a fluorescent brightening agent. A content of the fluorescent brightening agent in the developer is 0.3% by weight or more and 0.5% by weight or less.

### CROSS REFERENCE TO RELATED APPLICATIONS

This application claims priority under 35 USC 119 to Japanese Patent Application No. 2015-126095 filed on Jun. 24, 2015, the entire contents which are incorporated herein by reference.

### TECHNICAL FIELD

The present invention relates to a developer for use in developing an electrostatic latent image in an electrographic method, a developer container for accommodating a developer, a development apparatus using a developer, and an image forming apparatus.

1. Background

There are image forming apparatuses such as, e.g., color printers using an electrographic method, in which an image is formed using not only color toners such as yellow, magenta, cyan, etc., but also a clear toner (transparent developer) which does not contain coloring components to make glossiness of the surface of the print material uniform. The clear toner is produced by, for example, a dissolution suspension method (for example, see Patent Document 1).

2. Related Art

Japanese Laid-Open Patent Application Publication 2011-47998 (paragraphs 0058 to 0061)

Here, when the adhesion amount of the clear toner to the surface of the recording medium is increased, the yellow hue of the resin contained in the clear toner appears, causing a problem that there causes a difference in the color shade between a part in which a clear tone image is formed and a part in which a clear toner image is not formed.

The present invention was made in view of the aforementioned problem, and aims to suppress a color shade difference in a printed image.

### SUMMARY

A developer according to the present invention contains at least a binder resin and a fluorescent brightening agent, and a content of the fluorescent brightening agent in the developer is 0.3% by weight or more and 0.5% by weight or less.

A developer container according to the present invention accommodates the aforementioned developer.

A development apparatus according to the present invention develops an electrostatic latent image using the aforementioned developer.

An image forming apparatus of the present invention is equipped with the aforementioned development apparatus.

A method for producing a developer according to the present invention, comprises the steps of: obtaining an oil phase by dissolving and dispersing a binder resin and a fluorescent brightening agent in an organic solvent; obtaining a water phase by dispersing a suspension stabilizer in an aqueous medium; and obtaining a developer by introducing the oil phase in the water phase and dispersing them to granulate, wherein a content of the fluorescent brightening agent in the developer is set to 0.3% by weight or more and 0.5% by weight or less.

According to the present invention, by setting the content of the fluorescent brightening agent in the developer to 0.3% by weight or more and 0.5% by weight or less, the color shade difference between a part in which a developer image is formed and a part in which a developer image is not formed can be suppressed.

### BRIEF DESCRIPTION OF THE DRAWINGS

FIG. 1 is a view showing a general structure of an image forming apparatus according to Embodiment 1 of the present invention.

FIG. 2 is a view showing a structure of an image forming unit according to Embodiment 1.

FIG. 3 is a view showing an internal structure of a developer container according to Embodiment 1.

FIG. 4 is a schematic view showing a pattern used for a print test.

FIG. 5 is a schematic view showing a measurement method of a toner adhesion amount on a recording medium.

FIG. 6 is a table showing color differences on a recording medium when the toners in Examples 1 to 3 and Comparative Examples 1 to 4 are used.

FIG. 7 is a table showing color differences on a black base when the toners in Examples 1 to 3 and Comparative Examples 1 to 4 are used.

FIG. 8 is a table showing evaluation results of color differences when the toners in Examples 1 to 3 and Comparative Examples 1 to 4 are used.

### DETAILED DESCRIPTION OF THE EMBODIMENTS

### <Configuration of Image Forming Apparatus>

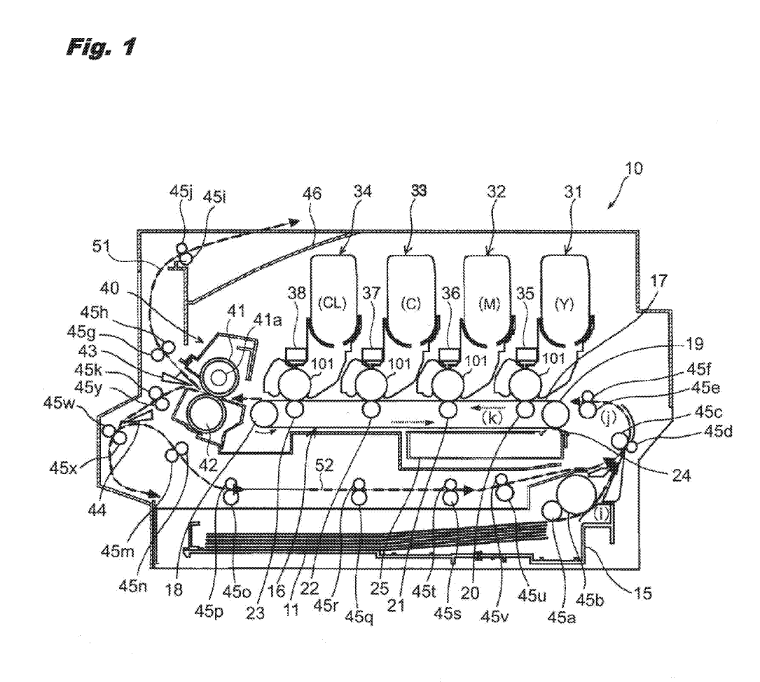

A structure of an image forming apparatus 10 which uses a toner as a developer according to this embodiment will be described. FIG. 1 shows a general structure of the image forming apparatus 10. The image forming apparatus 10 is configured to form an image using an electrographic system, and includes a medium cassette 15, image forming units 31, 32, 33, and 34, LED (Light Emitting Diode) heads 35, 36, 37, and 38, a transfer unit 16, and a fuser unit 40.

The medium cassette 15 is removably attached to the bottom part of the main body of the image forming apparatus 10. Inside the medium cassette 15, recording media 11 are accommodated in a stacked state. At a position contacting the upper surface of the recording medium 11 accommodated in the medium cassette 15, a pickup roller 45a is provided. The pickup roller 45a sends out the recording media 11 one by one from the medium cassette 15. A feed roller 45b is arranged adjacent to the pickup roller 45a. The feed roller 45b feeds the recording medium 11 in a direction shown by the arrow i.

Carrying rollers 45c and 45d and carrying rollers 45e and 45f are arranged along the carrying path of the recording medium 11 fed by the feed roller 45b. The carrying rollers 45c and 45d and the carrying rollers 45e and 45f correct the skew of the recording medium 11 and carry it toward the image forming units 31, 32, 33, and 34.

The image forming units 31, 32, 33, and 34 are each configured to form an image using yellow (Y), magenta (M), and cyan (C) toners along with a clear (CL) toner. Each of the image forming units 31, 32, 33, and 34 is equipped with a photosensitive drum 101 as an image carrier.

On the upper side of each of the photosensitive drums 101 of the image forming units 31, 32, 33, and 34, an LED head 35, 36, 37, and 38 as an exposure device is arranged so as to face the photosensitive drum. The LED head 35, 36, 37, and 38 includes, for example, an LED element and a lens array, and is arranged at a position where the irradiation light output from the LED element forms an image on the surface of the photosensitive drum 101.

The image forming units 31, 32, 33, and 34 have a common structure with the exception of the toner that is used. Here, the image forming unit 34 using a clear toner (transparent developer) will be described. The image forming unit 34 using a clear toner is arranged at the most downstream side among the image forming units 31, 32, 33, and 34. That is to form a clear toner image on top of the toner image of other colors.

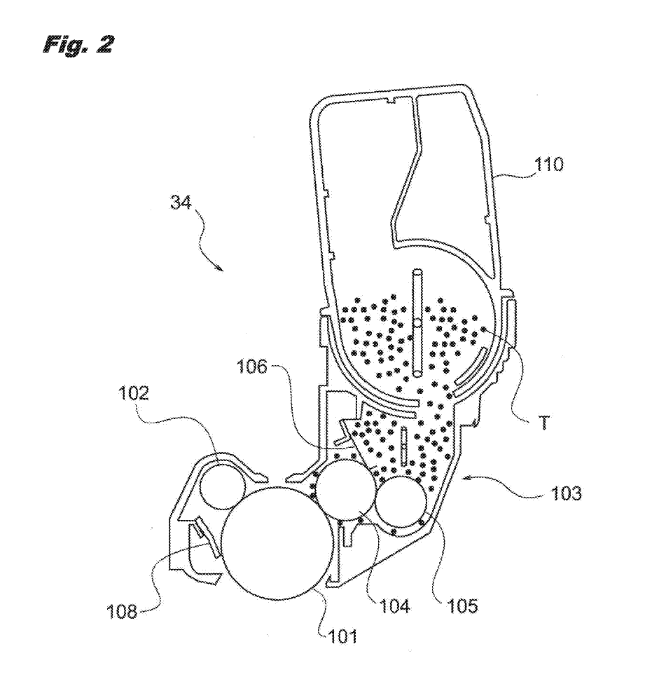

FIG. 2 shows a structure of the image forming unit 34. The image forming unit 34 includes a photosensitive drum 101 as a latent image carrier, a charge roller 102 as a charge member, a development roller 104 as a developer carrier, a supply roller 105 as a supply member, a development blade 106 as a layer regulation member, a developer container 110, and a cleaning blade 108 as a cleaning member.

The section including the development roller 104, the supply roller 105, the development blade 106 and the developer container 110 (the section contributing to the development of the electrostatic latent image) constitutes a development unit 103. In this embodiment, the image forming unit 34 (including the photosensitive drum 101, the charge roller 102, and the development unit 103) corresponds to the “development apparatus”. However, it is not limited to such a structure and only the section contributing to the development of the electrostatic latent image (development unit 103) can be the development apparatus.

The photosensitive drum 101 is constituted by laminating a photoreceptive layer (charge generation layer and charge transportation layer) on the surface of a conductive support made of aluminum, etc., and rotates in a clockwise direction in the drawing. The photoreceptive layer on the surface of the photosensitive drum 101 is exposed by the LED head 38 (FIG. 1), so that an electrostatic latent image is formed.

The charge roller 102 is constituted by, for example, a metal shaft and a semiconductive epichlorohydrin rubber layer, and is arranged so as to be in contact with the surface of the photosensitive drum 101. A charged voltage is applied to the charge roller 102, and the charge roller uniformly charges the surface of the photosensitive drum 101.

The development roller 104 is constituted by, for example, a metal shaft and a semiconductive urethane rubber layer, and is arranged so as to be in contact with the surface of the photosensitive drum 101. A development voltage is applied to the development roller 104, and the development roller 104 develops an electrostatic latent image on the surface of the photosensitive drum 101 with a toner.

The supply roller 105 is constituted by, for example, a metal shaft and a semiconductive foamed silicon sponge layer, and is arranged so as to face the development roller 104 in a manner as to be in contact with or spaced at a predetermined distance. A supply voltage is applied to the supply roller 105, and the supply roller 105 supplies a toner to the development roller 104.

The development blade 106 is, for example, a stainless blade, and is arranged so as to be in contact with the surface of the development roller 104. A blade voltage is applied to the development blade 106, and the development blade regulates a thickness of a toner layer on the surface of the development roller 104.

The cleaning blade 108 is, for example, a urethane rubber blade, and is arranged so as to be in contact with the surface of the photosensitive drum 101. The cleaning blade 108 removes the remaining toner remaining on the surface of the photosensitive drum 101.

The developer container 110 is a developer cartridge removably attached to the development unit 103. The developer container 110 accommodates a toner (developer) and supplies the toner to the development roller 104 and the supply roller 105. The developer container 110 of the image forming unit 34 accommodates a clear toner.

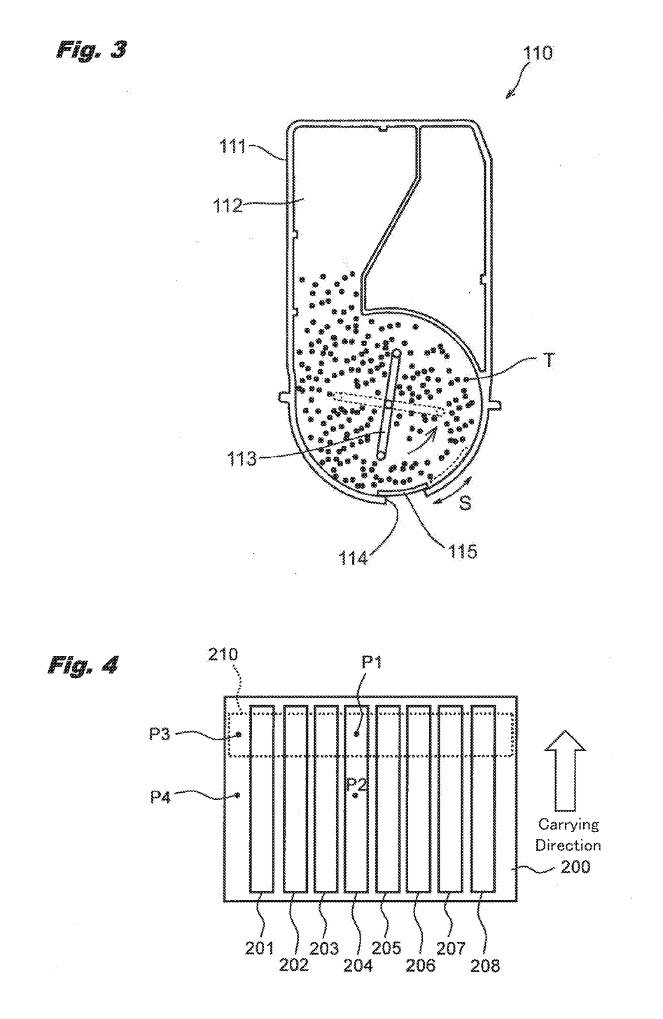

FIG. 3 is a view illustrating an internal structure of the developer container 110. As shown in FIG. 3, the developer container 110 includes, in its container 111, a developer accommodation part 112 for accommodating a toner (shown with a symbol T in FIG. 3). In the developer accommodation part 112, a stirring bar 113 extending in the longitudinal direction is rotatably supported. At the bottom of the developer container 110, an ejection port 114 for ejecting the toner in the developer accommodation part 112 is formed. To open and close the ejection port 114, a shutter 115 capable of sliding in the directions shown by an arrow Sin the drawing is provided.

Returning to FIG. 1, the transfer unit 16 is arranged below the image forming units 31, 32, 33, and 34. The transfer unit 16 includes a transfer belt 17, a drive roller 18, a tension roller 19, transfer rollers 20, 21, 22, and 23, a transfer belt cleaning blade 24, and a disposed developer tank 25.

The transfer belt 17 is constituted by polyamide-imide or polyamide, and carbon, etc., is added to obtain a predetermined conductivity and mechanical strength. The transfer belt 17 is put on the drive roller 18 and the tension roller 19, and drives with a recording medium 11 electrostatically absorbed on the surface to carry the recording medium along the image forming units 31, 32, 33, and 34. The drive roller 18 drives the transfer belt 17 by rotating in the counterclockwise direction in the drawing. The tension roller 19 is paired with the drive roller 18, and applies a constant tension to the transfer belt 17.

The transfer rollers 20, 21, 22, and 23 are arranged so as to be in contact with each of the photosensitive drums 101 of the image forming units 31, 32, 33, and 34 via the transfer belt 17. A transfer voltage is applied to the transfer rollers 20, 21, 22, and 23, and the transfer rollers transfer a toner image formed on the surface of each of the photosensitive drums 101 to a recording medium.

The transfer belt cleaning blade 24 is arranged so as to be in contact with the surface of the transfer belt 17, and scrapes the toner adhered to the surface of the transfer belt 17 for cleaning. The disposed developer tank 25 is a container for accommodating the toner scraped by the transfer belt cleaning blade 24.

In the carrying direction of the recording medium, a fuser unit 40 is arranged on the downstream side of the image forming units 31, 32, 33, and 34 and the transfer unit 16. The fuser unit 40 is equipped with a heat roller 41 and a pressure application roller 42.

The heat roller 41 is a roller in which, for example, a hollow cylindrical core shaft made of aluminum is covered with a silicon rubber heat-resistant elastic layer and covered with a PFA (tetrafluoroethylene-perfluoroalkyl vinyl ether copolymer) tube on top of that. In the core shaft, for example, a heat application heater 41a such as a halogen lamp is provided.

The pressure application roller 42 is a roller in which, for example, an aluminum core shaft is covered with a silicon rubber heat-resistant elastic layer and covered with a PFA tube on top of that. The pressure application roller 42 is arranged so that a press-contact part (nip part) is formed between the pressure application roller 42 and the heat roller 41.

On the downstream side (left side of the drawing) of the fuser unit 40 in the carrying direction of the recording medium 11, a switching guide 43 for switching the carrying path of the recording medium 11 is provided. The switching guide 43 is configured to selectively carry the recording medium 11 sent out from the fuser unit 40 to an ejection carrying path 51 or a re-carrying path 52.

In the ejection carrying path 51, carrying rollers 45g and 45h and ejection rollers 45i and 45j for ejecting the recording medium 11 sent out from the fuser unit 40 to the outside of the image forming apparatus 10 are provided. Further, at the upper cover of the image forming apparatus 10, a stacker part 46 configured to load ejected recording media 11 is provided.

On the re-carrying path 52, carrying rollers 45k and 45y, a switching guide 44, and carrying rollers 45w and 45x configured to first retreat a recording medium 11 carried through the switching guide 43 to a retreat path and then send it out in the reverse direction are provided. Further, on the re-carrying path 52, carrying rollers 45m and 45n, carrying rollers 45o and 45p, carrying rollers 45q and 45r, carrying rollers 45s and 45t, and carrying rollers 45u and 45v configured to carry the recording medium 11 to the aforementioned carrying rollers 45c and 45d are provided.

### <Operation of Image Forming Apparatus>

Next, the operation of the aforementioned image forming apparatus 10 will be described. The recording media 11 accommodated in the medium cassette 15 are sent out one by one by the pickup roller 45a and the feed roller 45b from the medium cassette 15 in the direction shown by the arrow i. The recording medium 11 sent out from the medium cassette 15 is carried in the direction of the arrow j by the carrying rollers 45c and 45d and the carrying rollers 45e and 45f while the skew is being corrected.

The transfer belt 17 of the transfer unit 16 is driven by the rotation of the drive roller 18, absorbs the recording medium carried by the carrying rollers 45e and 45f and carries it in the direction of the arrow k.

In the image forming unit 31, the photosensitive drum 101 rotates at a constant speed in the clockwise direction shown in the drawing. The charge roller 102 (FIG. 2) rotates by being driven by the photosensitive drum 101 and uniformly charges the surface of the photosensitive drum 101. The LED head 35 exposes the surface of the photosensitive drum 101 based on yellow image data and forms an electrostatic latent image.

Further, the supply roller 105 (FIG. 2) supplies the toner supplied from the developer container 110 to the development roller 104. On the surface of the development roller 104, a toner thin layer of which the thickness is regulated by the development blade 106 is formed. The toner thin layer on the surface of the development roller 104 adheres to the electrostatic latent image on the surface of the photosensitive drum 101, and with this, an electrostatic latent image is developed and becomes a toner image (developer image).

The yellow toner image formed on the surface of the photosensitive drum 101 is transferred to the recording medium 11 on the transfer belt 17 by the transfer voltage applied to the transfer roller 20.

Similarly, when the recording medium 11 is carried by the transfer belt 17 and passes the image forming units 32, 33, and 34, magenta and cyan toner images as well as a clear toner image are sequentially transferred to the recording medium 11.

The recording medium 11 to which the toner image of each color is transferred is carried to the fuser unit 40 by the transfer belt 17. In the fuser unit 40, heat and pressure are applied to the recording medium 11 by the heat roller 41 and the pressure application roller 42, thereby melting the toner image and fusing it to the recording medium 11. The recording medium 11 in which the toner image is fused is carried along the ejection carrying path 51 by the carrying rollers 45g and 45h and the ejection rollers 45i and 45j, ejected to the outside of the image forming apparatus 10, and loaded on the stacker part 46.

Further, in the case of double-sided printing, after the front and back of the recording medium 11 sent out from the fuser unit 40 is inverted by the switching guide 44, the carrying rollers 45k and 45y and the carrying rollers 45w and 45x, the recording medium 11 is carried along the re-carrying path 52 by the switching guide 44, the carrying rollers 45m and 45n, the carrying rollers 45o and 45p, the carrying rollers 45q and 45r, the carrying rollers 45s and 45t, and the carrying roller 45u and 45v, reaches the carrying rollers 45c and 45d, and the image forming on the back side is performed.

### <Developer>

Next, a toner as a developer of this embodiment will be explained. This embodiment relates to the aforementioned clear toner. The clear toner (transparent developer) is a toner that does not include a coloring agent, but includes a white fluorescent agent instead, and is produced using a dissolution suspension method.

Specifically, through a step for preparing an oil phase (dispersion phase) by dissolving and dispersing a binder resin, a fluorescent brightening agent and a release agent in an organic solvent, a step for preparing a water phase (continuous phase) by dispersing a suspension stabilizer in an aqueous medium, a granulation step for generating oil drops by introducing and dispersing the oil phase into the water phase, and a distillation step for removing the organic solvent from the oil drop and then cleaning and drying, a toner mother particle (mother particle of the developer) is obtained. By adding an external additive to the toner mother particle, a toner (developer) is produced.

As an organic solvent of the oil phase, for example, a hydrocarbon solvent such as xylene, hexane, etc., an ester solvent such as methyl acetate, ethyl acetate, butyl acetate, isopropyl acetate, etc., an ether solvent such as diethyl ester, etc., and a ketone solvent such as acetone, methyl ethyl ketone, diisobutyl ketone, cyclohexanone, methylcyclohexane, etc., can be used.

As a binder resin (binding resin), for example, a thermoplastic resin such as vinyl resin, polyamide resin, polyester resin, polyurethane resin, etc., can be used. In the case a polyester resin, a polyester resin with a glass transition temperature Tg of 59.3 to 61° C. and a melting point Tm of 106.7 to 110.2° C. is used.

As the fluorescent brightening agent, for example, a benzoxazole-based fluorescent brightening agent can be used. More specifically, for example, a fluorescent brightening agent having a chemical name of 2,2′-(2,5-thiophenediyl)bis5-1(1,1-dimethylethyl) benzoxazole and a product name of “Tinopal OB CO” (manufactured by BASF Corp.) can be used.

As a release agent, for example, a higher fatty acid and its metal salt, a fatty acid amide, an ester wax, a paraffin/polyolefin wax, and an aliphatic hydrocarbon wax and modified product thereof can be used. Considering the easy preparation the wax dispersion in the dissolution suspension method and the easy incorporation into the toner, an aliphatic hydrocarbon wax or an ester wax are preferably used.

Further, in this example, a charge control agent is not added, but it is possible to add a charge control agent.

As an aqueous medium of the water phase, for example, pure water can be used. As a suspension stabilizer, for example, trisodium phosphate, calcium carbonate, calcium chloride, hydrocarbon sodium, hydrocarbon potassium, hydroxyapatite, and calcium phosphate can be used.

Further, silica (for example, hydrophobic silica) as an external additive is added to the toner mother particle produced by the dissolution suspension method. As silica, for example, “RY50” (average primary particle diameter 40 nm) produced by Nippon Aerosil Co., Ltd., “X24-9163A” produced by Shin-etsu Silicones Co., Ltd., “VPRY40S” produced by Nippon Aerosil Co,. Ltd., and “EPOSTAR S” produced by Nippon Shokubai, Co., Ltd. can be used.

In addition, when producing color toners other than clear toners (black, yellow, magenta, cyan, etc.), a coloring agent is added instead of the aforementioned fluorescent brightening agent. As a black coloring agent, for example, there is carbon black. As a yellow coloring agent, for example, there is pigment yellow. As a magenta coloring agent, for example, there is pigment red. As a cyan coloring agent, for example, there is pigment blue.

Production methods of the clear toner of Examples 1 to 3 of this embodiment and Comparative Examples 1 to 4 for comparison will be explained.

### Example 1

First, 11,924 parts by weight of trisodium phosphate as a suspension stabilizer was added to 329,678 parts by weight of pure water as an aqueous medium and dissolved at a liquid temperature of 60° C. In the obtained solution, a calcium chloride aqueous solution in which 5,319 parts by weight of calcium chloride anhydride was dissolved in 43,234 parts by weight of pure water was introduced. Then, using a “Neomixer” produced by Primix Corporation, it was stirred at a rotational speed of 4,300 rpm for 50 minutes while maintaining the liquid temperature at 60° C. With this, a water phase including a suspension stabilizer was produced.

Further, 76,566 parts by weight of ethyl acetate as an organic solvent was heated to a liquid temperature of 50° C. and mixed, and 1,552 parts by weight of paraffin wax as a release agent and 40.35 parts by weight of fluorescent brightening agent were sequentially added. After that, 19,091 parts by weight of polyester resin as a binder resin was added and completely dissolved. With this, an oil phase including a binder resin and a release agent was produced. As a preferred embodiment, the release agent may be contained by weight in a range from 18 to 22%.

Next, an oil phase was introduced to the aforementioned water phase, and using the “Neomixer” produced by Primix Corporation, granulation was performed at a rotational speed of 1,700 rpm for 50 minutes while maintaining a liquid temperature of 55° C. to produce oil drops. After the granulation, ethyl acetate (organic solvent) was removed by vacuum distillation and a slurry including the toner was obtained.

The slurry solution containing the produced toner was washed and through the further steps of crushing, drying and classifying, toner mother particles were obtained.

Next, as an external additive step, silica (the aforementioned hydrophobic silica “RY50”) as an external additive was added to 100% by weight of the aforementioned toner mother particle, and it was mixed to produce a toner A.

In the toner A of Example 1, the content of the fluorescent brightening agent in the whole toner was 0.3% by weight. Further, the content of the fluorescent brightening agent in the toner was calculated from the compounded amount of each of the solid contents when preparing the aforementioned oil phase (dispersion phase).

### Example 2

In the toner production step of Example 1, the content of the fluorescent brightening agent in the toner was changed to 0.4% by weight and the other conditions were set to be the same as the toner production method of Example 1 to produce a toner B.

### Example 3

In the toner production step of Example 1, the content of the fluorescent brightening agent in the toner was changed to 0.5% by weight and the other conditions were set to be the same as the toner production method of Example 1 to produce a toner C.

### Comparative Example 1

In the toner production step of Example 1, the content of the fluorescent brightening agent in the toner was changed to 0.1% by weight and the other conditions were set to be the same as the toner production method of Example 1 to produce a toner D.

### Comparative Example 2

In the toner production step of Example 1, the content of the fluorescent brightening agent in the toner was changed to 0.2% by weight and the other conditions were set to be the same as the toner production method of Example 1 to produce a toner E.

### Comparative Example 3

In the toner production step of Example 1, the content of the fluorescent brightening agent in the toner was changed to 0.7% by weight and the other conditions were set to be the same as the toner production method of Example 1 to produce a toner F.

### Comparative Example 4

In the toner production step of Example 1, the content of the fluorescent brightening agent in the toner was changed to 1.0% by weight and the other conditions were set to be the same as the toner production method of Example 1 to produce a toner G.

### <Print Test>

Using the toners A to G of the aforementioned Examples 1 to 3 and Comparative Examples 1 to 4, print tests were performed using the image forming apparatus 10 as shown in FIG. 1. As the image forming apparatus 10, “MicroLine 910PS”, a color printer produced by Oki Data Corporation, was used.

As a recording medium, “color copy” (120 g/m² of basis weight) produced by Mondi Corp. was used and the size was A4 (transverse feed). Further, a recording medium in which yellow, magenta, cyan, black, red, green, blue, and composite black patterns were printed in advance was used. The environmental temperature was set to 20° C. and the relative humidity was set to 20%.

FIG. 4 shows the pattern used for printing. Here, for the A4 size recording medium (shown by the symbol 200 in FIG. 4), a recording medium in which eight patterns 201, 202, 203, 204, 205, 206, 207, and 208 were formed in advance using yellow, magenta, cyan, black, red, green, blue, and composite black toners was used. Each of the patterns 201 to 208 is arranged in one line in the horizontal direction (orthogonal direction to the carrying direction of the recording medium) and is a vertically long rectangular shape in which the length in the longitudinal direction (carrying direction of the recording medium) was 175 mm and the length in the transverse direction was 20 mm.

The pattern 210 as shown by the broken line in FIG. 4 was formed on the surface of the recording medium in which these patterns 201 to 208 were printed in advance using a clear toner.

The pattern of the clear toner was a horizontally long rectangle shape in which the length in the longitudinal direction was 50 mm and the length in the transverse direction was 260 mm.

The print test was performed under three print conditions so that the toner adhesion amount on the recording medium became 0.5 mg/cm², 1.0 mg/cm² and 1.5 mg/cm².

FIG. 5 is a view schematically showing a measurement method of the adhesion amount of the clear toner on the recording medium. First, using the image forming apparatus 10 (the aforementioned color printer “MicroLine 910PS), a solid image 301 was transferred onto the entire face of the recording medium 300 and the image forming apparatus 10 was stopped before the recording medium 300 reached the fuser unit 40 (FIG. 1) to obtain an unfused solid image 301. Then, using a jig 304 in which a square double-sided tape 303 having 1 cm sides were pasted on the surface of the metal member 302 having a square surface in which one side was 1 cm, the surface of the jig 304 was pressed to the solid image 301 and detached therefrom, and the weight of the toner adhered to the double-sided tape 303 was measured. The measured positions were three positions: the left end part; the central part; and the right end part of the solid image 301, and the average value was obtained.

The adjustment method of the adhesion amount of the clear toner in the print test was as follows. That is, among the image forming units 31, 32, 33, and 34 of the image forming apparatus 10, the image forming unit 34 was not used, clear toners were filled in the image forming units 31, 32, and 33, and the development voltage, the transfer voltage, etc., were adjusted so that the toner adhesion amount on the recording medium in each of the image forming units became 0.5 mg/cm².

Then, by only operating the image forming unit 31 among the image forming units 31, 32, 33 and 34, 0.5 mg/cm² of the toner was adhered to the recording medium. Further, by operating the image forming units 31 and 32, 1.0 mg/cm² of the toner was adhered to the recording medium. Further, by operating the image forming units 31, 32, and 33, 1.5 mg/cm² of the toner was adhered to the recording medium.

Furthermore, the reason that the print test was performed in which the adhesion amount of the toner on the recording medium was in the range of 0.5 mg/cm² to 1.5 mg/cm² is because, when the adhesion amount of the toner on the recording medium is less than 0.5 mg/cm², the glossiness (gloss) which is a characteristic of the clear toner decreases and when exceeding 1.5 mg/cm², the yellow hue and the blue hue of the print material increase by the ingredients contained in the clear toner.

### <Measurement of Color Difference>

After forming clear toner patterns under the aforementioned conditions, the color differences were measured using a “X-rite528” produced by X-Rite Inc. That is, for the same base, the color difference between a part in which the clear toner was formed and a part in which the clear toner was not formed was measured.

Here, as shown in FIG. 4, for a black pattern 204 formed on the recording medium 200, the color difference was measured at the measurement position P1 inside the clear toner pattern 210 and the measurement position P2 outside the clear toner pattern 210. The color difference was referred to as a color difference on the black base.

Similarly, for magenta, cyan, red, green, blue, and composite black, the color difference was measured at the measurement position inside the clear toner pattern 210 and the measurement position outside the clear toner pattern 210.

Further, on the surface of the recording medium 200, the color difference was measured at the measurement position P3 inside the clear toner pattern 210 and the measurement position P4 outside the clear toner pattern 210. The color difference is referred to as a color difference on the recording medium.

### <Test Results>

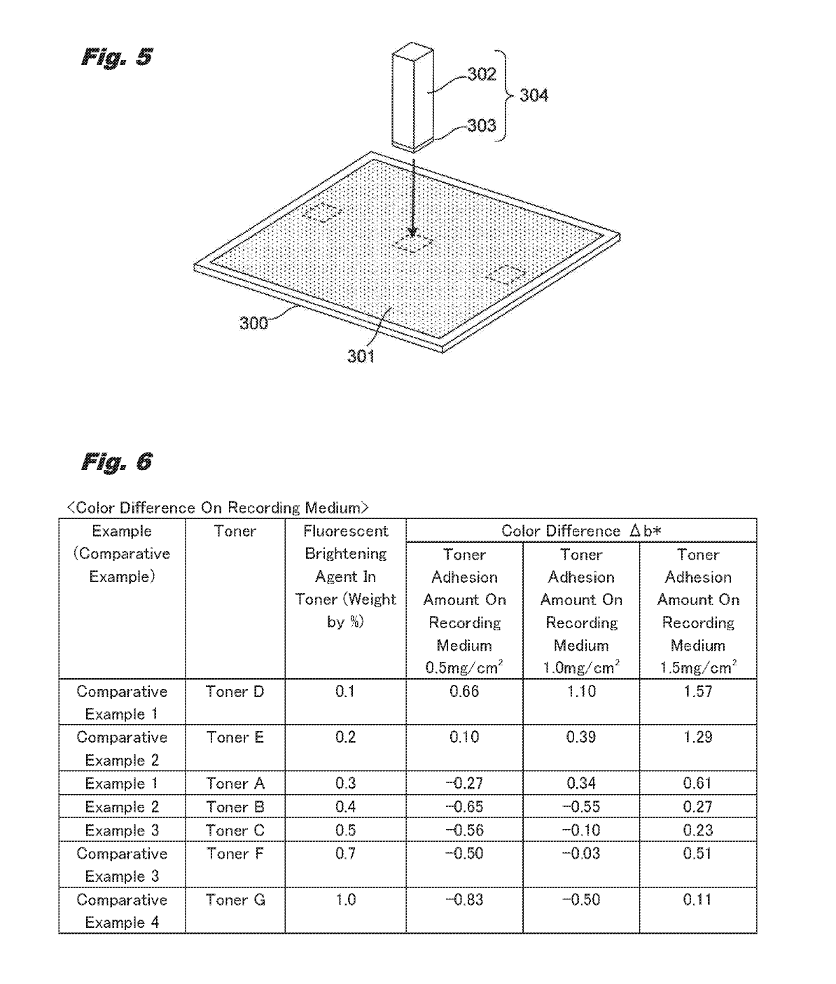

FIG. 6 shows measurement results of color differences on a recording medium when the toners A to G in Examples 1 to 3 and Comparative Examples 1 to 4 were used. As shown in FIG. 6, in Comparative Examples 1 and 2 (the content of the fluorescent brightening agent in the toner was 0.1% by weight to 0.2% by weight), the color difference Δb* on the recording medium was 1.29 or more when the adhesion amount on the recording medium was 1.5 mg/cm². On the clear toner image on the recording medium, yellow hue was visually observed. This is considered to be a result of appearance of the hue of the polyester resin which is the binder resin of the clear toner.

On the other hand, in Examples 1 to 3 and Comparative Examples 3 and 4 (the content of the fluorescent brightening agent in the toner was 0.3% by weight or more), the color difference Δb* on the recording medium was less than 1.29 and significant color difference was not visually observed.

Further, when the toner adhesion amounts on the recording medium were 0.5 mg/cm² and 1.0 mg/cm², in all of Examples 1 to 3 and Comparative Examples 1 to 4, the color difference Δb* on the recording medium was less than 1.29 and significant color difference was not visually observed.

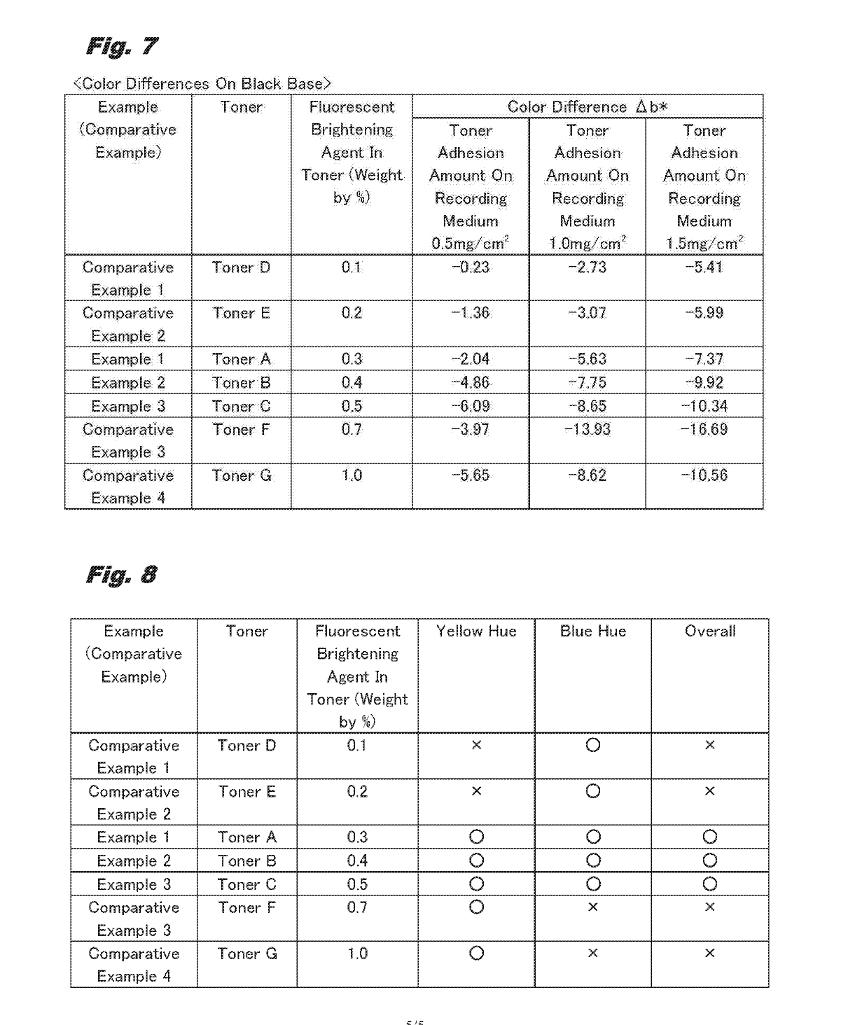

FIG. 7 shows the color differences on a black base when the toners A to G in Examples 1 to 3 and Comparative Examples 1 to 4 were used. As shown in FIG. 7, in Comparative Examples 3 and 4 (the content of the fluorescent brightening agent in the toner is 0.7% by weight to 1.2% by weight), the color difference Δb* on the black base was −10.56 or less when the toner adhesion amount was 1.5 mg/cm². On a clear toner image on the black base, blue hue was visually observed. This is considered to be a result of appearance of the hue of the fluorescent brightening agent of the clear toner.

On the other hand, in Examples 1 to 3 and Comparative Examples 1 and 2 (the content of the fluorescent brightening agent in the toner was 0.5% by weight or less), the color difference Δb* on the black base was more than −10.56 and significant color difference was not visually observed.

Further, when the toner adhesion amount on the recording medium was 0.5 mg/cm² and 1.0 mg/cm², in all of Examples 1 to 3 and Comparative Examples 1 to 4, the color difference Δb* on the black base was more than −10.56 and significant color difference was not visually observed.

Further, when clear toner images were formed on magenta, cyan, black, red, green and blue bases, significant color differences between a part in which clear toner images were formed and a part in which clear toner images were not formed were not observed. Furthermore, when clear toner images were formed on a composite black base, approximately the same results as when clear toner images were formed on a black base were obtained.

FIG. 8 shows a summary of evaluation results when using toners A to G in Examples 1 to 3 and Comparative Examples 1 to 4. As shown in FIG. 8, in Comparative Examples 1 and 2 (the content of the fluorescent brightening agent in the toner was 0.1% by weight to 0.2% by weight), color differences (yellow hue) were observed on the recording medium. Further, in Comparative Examples 3 and 4 (the content of the fluorescent brightening agent in the toner was 0.7% by weight to 1.0% by weight), color differences (blue hue) were observed on the black base.

On the other hand, in Examples 1 to 3 (the content of the fluorescent brightening agent in the toner was 0.3% by weight to 0.5% by weight), color differences were not observed on the recording medium nor any of magenta, cyan, black, red, green, blue and composite black bases.

From these results, it can be understood that, when the toner adhesion amount on the recording medium is in a range of 0.5 mg/cm² to 1.5 mg/cm², the color differences for the part in which the clear toner image is formed and the part in which the clear toner image is not formed can be suppressed when the content of the fluorescent brightening agent in the toner is within the range of 0.3% by weight and 0.5% by weight.

As explained above, according to Embodiment 1 of the present invention, by setting the content of the fluorescent brightening agent in the developer in a range of 0.3% by weight to 0.5% by weight, the color difference between the part in which the developer image is formed and the part in which the developer image is not formed can be suppressed and excellent images can be obtained.

Further, by setting a color difference Δb* of a part in which the developer image is formed and a part in which the developer image is not formed to be smaller than 1.29 when a developer image is formed on a recording medium so that the adhesion amount of the developer on the recording medium is 0.5 mg/cm² to 1.5 mg/cm², and by setting the color difference Δb* of a part in which the developer image is formed and a part in which the developer image is not formed to be larger than −10.56 when the developer image is formed on a black image so that the adhesion amount of the developer is 0.5 mg/cm² to 1.5 mg/cm², an excellent image in which a significant color difference cannot be visually observed can be obtained.

Here, a printer was explained as one example of the image forming apparatus, but the present invention can be applied not only to printers, but also to photocopiers, facsimile devices, and MFPs (Multifunction Peripherals).

Furthermore, here, the clear toner (transparent developer) was explained as one example of the developer, but the present invention can be applied to any developer including a fluorescent brightening agent.

What is claimed is:

1. A developer containing at least a binder resin and a fluorescent brightening agent, wherein a content of the fluorescent brightening agent in the developer is 0.3% by weight or more and 0.5% by weight or less.

2. The developer according to claim 1, wherein
the fluorescent brightening agent is contained in the developer to satisfy follows:
when an image of the developer is formed on a recording medium and an adhesion amount of the developer on the recording medium is 0.5 mg/cm² or more and 1.5 mg/cm² or less, a color difference Δb* between a part in which the image of the developer is formed and a part in which the image of the developer is not formed is smaller than 1.29, and
when an image of the developer is formed on a black image and when an adhesion amount of the developer on the black image is 0.5 mg/cm² or more and 1.5 mg/cm² or less, a color difference Δb* between a part in which the developer image is formed and a part in which the developer image is not formed is larger than −10.56.

3. The developer according to claim 1, wherein
the binder resin is a vinyl resin, a polyamide resin, a polyester resin, or a polyurethane resin.

4. The developer according to claim 1, wherein
the fluorescent brightening agent is a benzoxazole-based fluorescent brightening agent.

5. The developer according to claim 4, wherein
the fluorescent brightening agent is a 2,2′-(2,5-thiophenediyl)bis5-1(1,1-dimethylethyl) benzoxazole.

6. The developer according to claim 1, wherein
the developer further contains a release agent.

7. The developer according to claim 6, wherein
a content of the release agent by weight is ranged from 18% to 22%.

8. The developer according to claim 1, wherein
the developer is produced by a dissolution suspension method.

9. A developer container accommodating the developer according to claim 1.

10. A development apparatus that develops an electrostatic latent image using the developer according to claim 1.

11. An image forming apparatus comprising the development apparatus according to claim 10.

12. A method for producing a developer, the method comprising the steps of:
obtaining an oil phase by dissolving and dispersing a binder resin and a fluorescent brightening agent in an organic solvent;
obtaining a water phase by dispersing a suspension stabilizer in an aqueous medium; and
obtaining a developer by introducing the oil phase in the water phase and dispersing them to granulate,
wherein a content of the fluorescent brightening agent in the developer is set to 0.3% by weight or more and 0.5% by weight or less.
